(19) United States
(12) Patent Application Publication
(10) Pub. No.: US 2026/0066700 A1
(43) Pub. Date: Mar. 5, 2026

(54) REDUCING ENERGY CONSUMPTION OF SMART SOCKETS WITH PLUG DETECTION SENSORS

(71) Applicant: Honeywell International Inc., Charlotte, NC (US)

(72) Inventors: Asan P, Tuticorin (IN); Saravana Balaji B, Pollachi (IN); Ramanjaneyulu Karnati, Palnadu (IN); Ram Prasad, Chengalpattu (IN)

(21) Appl. No.: 18/821,839

(22) Filed: Aug. 30, 2024

(51) Int. Cl. H02J 13/00; H01R 13/66; H01R 13/703

(52) U.S. Cl. CPC H02J 13/38; H01R 13/6683; H01R 13/703; H02J 13/1331

(57) ABSTRACT

A system comprising smart sockets each having a plug receptacle, a plug detection sensor; and a socket controller configured to switch power off or on to the plug receptacle; and a supervisor configured to detect a change in a plug state, in response to identifying a change from the plug absent state to the plug present state, the supervisor is configured to send a control signal to a smart socket of one or more of the smart sockets that causes the corresponding socket controller to switch on power to the corresponding plug receptacle of the smart socket; and in response to identifying a change from the plug present state to the plug absent state, the supervisor sends a control signal to the smart socket of one or more of the smart sockets that causes the corresponding socket controller to switch off power to the corresponding plug receptacle.

### TECHNICAL FIELD

The present disclosure relates generally to smart sockets (e.g., smart electrical sockets), and more particularly to smart sockets with a plug detection sensor providing a plug detection functionality. For instance, the smart sockets with the plug detection sensor can yield energy savings to a facility (e.g., reduced energy consumption) by being selectively switched on and/or off based on a plug state (e.g., whether a plug is present or absent in the smart sockets) detected by the plug detection sensor.

### BACKGROUND

Smart sockets provide power to a variety of different devices with corresponding plugs that are plugged into a smart socket and thus draw a plug load from the smart socket. Examples of plug loads include those attributed to equipment (e.g., office equipment) such as computer monitors, task lighting, coffeemakers, vending machines and/or the sockets, etc., among other types of equipment. Smart sockets can include circuitry (e.g., a socket controller) that allows a user or a supervisor to remotely control the smart socket, for instance, to control whether the smart socket provides power to a device that is connected via a corresponding plug to a plug receptacle (e.g., receptacle) of the smart socket. However, whether a particular smart socket is connected via a plug to equipment may, at least in some instances, be unknown (e.g., from the perspective of building management and/or the supervisor). For instance, equipment may not be connected to a smart socket, yet the smart socket may remain powered on (e.g., due to a power schedule associated with the smart socket). Thus, in various instances the smart socket may remain powered on at all times and thereby consume energy even though it may not be necessary to have the smart socket remain powered on at a particular time. It is desirable to have smart sockets that automatically permit reducing energy consumption of a facility in which the smart socket is located.

### SUMMARY

The present disclosure relates generally to smart sockets, and more particularly to smart sockets that provide a plug detection sensor with a plug detection functionality. An example may be found in a smart socket that includes a housing that houses one or more plug receptacles each for receiving an electrical plug, one or more power connections for connecting to a power source, and a power input port for receiving input power from the one or more power connections. The housing houses one or more plug detection sensors configured to detect a presence of one or more plugs disposed in the one or more plug receptacles. The one or more plug detection sensors provide an easy and automatic way to detect whether or not a plug for equipment is connected to the smart socket, thereby permitting the smart socket to be selectively powered on (e.g., when a plug is detected) or powered off (e.g., when an absence of a plug is detected). For instance, a supervisor can be operatively coupled (e.g., wirelessly coupled) to each of the one or more smart sockets and can be configured to detect a change in a plug state of the plug receptacle based on information indicative of the plug state that is received from the plug detection sensor. In some instances, in response to identifying that the plug state changed from the plug absent state to the plug present state, the supervisor is configured to send a control signal to a smart socket of the one or more of the smart sockets that causes the corresponding socket controller to switch on power to the corresponding plug receptacle of the smart socket. In some instances, in response to identifying that the plug state change from the plug present state to the plug absent state, the supervisor is configured to send a control signal to the smart socket of the one or more of the smart sockets that causes the corresponding socket controller to switch off power to the corresponding plug receptacle of the smart socket.

A first example may be found in a system for controlling energy consumption of a building, the system comprising: one or more smart sockets located in the building each having: a plug receptacle for receiving a plug from a corresponding electrical appliance, a plug detection sensor configured to detect a plug state of the plug receptacle, wherein the plug state includes a plug present state and a plug absent state; and a socket controller that is configured to switch power on or off to the plug receptacle; and a supervisor operatively coupled to each of the one or more smart sockets, the supervisor configured to detect a change in a plug state of the plug receptacle based on information indicative of the plug state that is received from the plug detection sensor, wherein: in response to identifying that the plug state changed from the plug absent state to the plug present state, the supervisor is configured to send a control signal to a smart socket that causes the corresponding socket controller to switch on power to the corresponding plug receptacle in the socket; and in response to identifying that the plug state change from the plug present state to the plug absent state, the supervisor is configured to send a control signal to the smart sockets that causes the corresponding socket controller to switch off power to the corresponding plug receptacle in the smart socket.

Another example may be found in a method for reducing energy consumption of a region of a facility, comprising: receiving, from a plug detection sensor in a smart socket including a plug receptacle, a signal indicative of a first plug state of the plug receptacle, wherein the first plug state is a plug present state or a plug absent state; receiving, from the plug detection sensor, a signal indicative of a second plug state of the plug receptacle, wherein the second plug state is the other of the plug present state or the plug absent state; identifying a change from the first plug state to the second plug state; and responsive to identifying the change, sending a control signal to automatically switch power off or switch power on to the plug receptacle.

Another example may be found in a supervisor operatively coupled to a plurality of smart sockets in a building, each of the plurality of smart sockets having a housing including one or more plug receptacles and one or more plug detection sensors, the supervisor comprising: a memory storing non-transitory machine readable instructions; and a processing device operatively coupled to the memory and configured to execute the non-transitory machine readable instructions to: receive, from a plug detection sensor in a respective smart socket of the plurality of smart sockets, a signal indicative of a first plug state of a respective plug receptacle in the respective smart socket, wherein the first plug state corresponds to a plug present state of the respective plug receptacle or a plug absent state of the respective plug receptacle; receive, from the plug detection sensor, a signal indicative of a second plug state of the plug receptacle in the respective smart socket, wherein the second plug state is the other of the plug present state or the plug absent state; identify a change from the first plug state to the second plug state; and responsive to identification of the change, send a control signal to automatically switch power off or switching power on to the plug receptacle.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative system;

FIG. 2 is a schematic block diagram of an illustrative system;

FIG. 3 is a schematic block diagram of an illustrative smart socket;

FIG. 4A is a front perspective view of an illustrative smart socket;

FIG. 4B is a front perspective view of another illustrative smart socket;

FIG. 5 is a flow diagram showing an illustrative method for controlling energy consumption of a building based on a plug state detected by a plug state detector of a smart socket; and

FIG. 6 is a flow diagram showing an illustrative method for controlling energy consumption of a building based on a plug state detected by a plug state detector of a smart socket.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranged by endpoints includes all numbers subsumed within that range (e.g., 1 to 5 includes, 1, 1.5, 2, 2.75, 3, 3.8, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

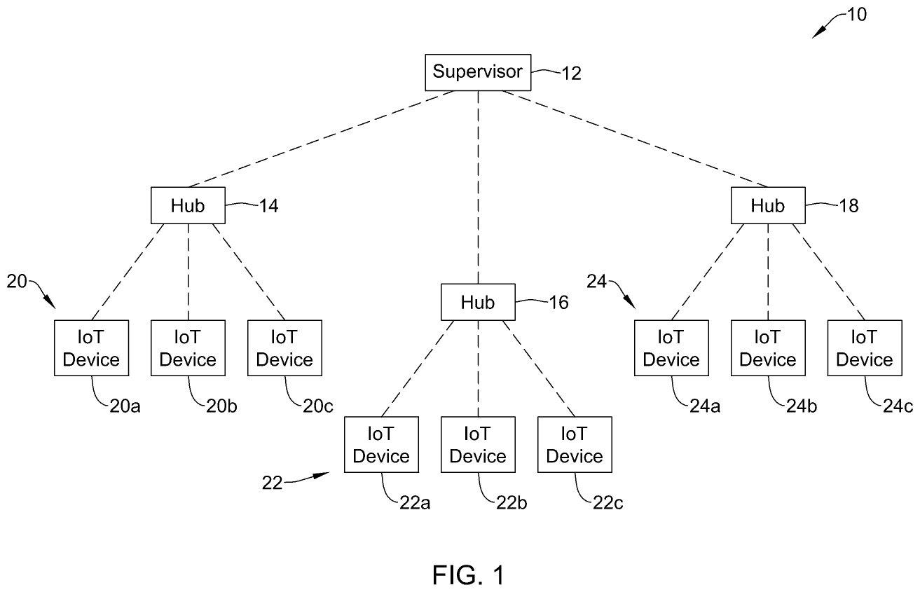

FIG. 1 is a schematic block diagram showing an illustrative system 10. The illustrative system 10 includes a supervisor 12, a first gateway hub 14, a second gateway hub 16 and a third gateway hub 18. While a total of three gateway hubs 14, 16 and 18 are shown, it will be appreciated that this is merely illustrative, as the system 10 may include any number of gateway hubs. The system 10 includes a number of IoT (Internet of Things) devices, divided into a first group of IoT devices 20, a second group of IoT devices 22 and a third group of IoT devices 24. The IoT devices within the first group of IoT devices 20 are individually labeled as 20a, 20b and 20c. The IoT devices within the second group of IoT devices 22 are individually labeled as 22a, 22b and 22c. The IoT devices within the third group of IoT devices 24 are individually labeled as 24a, 24b and 24c. This is merely illustrative, as the first group of IoT devices 20, the second group of IoT devices 22 and/or the third group of IoT devices 24 may each include any number of IoT devices, and in some cases may include a substantially larger number of IoT devices.

Each of the IoT devices 20, the IoT devices 22 and the IoT devices 24 may independently be any of a variety of different IoT devices. In general, IoT devices are physical objects having sensors, processing ability, software and/or other technologies that allow the devices to connect with and exchange data with other devices and systems over the Internet and/or other communication networks. IoT devices can include home automation devices, elder care devices, medical devices, transportation devices, vehicle to vehicle communication devices, building automation devices, industrial devices, maritime devices, infrastructure devices, energy management devices, environmental monitoring devices, and others.

In some cases, a smart socket may be considered as being an example of an IoT device. A smart socket includes an electrical plug receptacle (e.g., plug receptacle) that provides power to a device that is plugged into the electrical plug receptacle. In some cases, a smart socket includes circuitry that is able to monitor various aspects of the power being provided to the device, as well as communications circuitry that allows the smart socket to report those power aspects to another device such as a gateway hub and/or supervisor. In some cases, a smart socket can include circuitry that allows a user to remotely control the smart socket to control whether the smart socket provides power to a device that is connected to a plug receptacle of the smart socket. These are just examples. The smart socket can include one or more plug detection sensors, as described herein.

In some instances, the first group of IoT devices 20 and the first gateway hub 14 may together be considered as forming a first wireless mesh network, the second group of IoT devices 22 and the second gateway hub 16 may together be considered as forming a second wireless mesh network, and the third group of IoT devices 24 and the third gateway hub 18 may together be considered as forming a third wireless mesh network. The devices within the first wireless mesh network communicate in normal circumstances with only the other devices within the first wireless mesh network. The devices within the second wireless mesh network communicate in normal circumstances with only the other devices within the second wireless mesh network. The devices within the third wireless mesh network communicate in normal circumstances with only the other devices within the third wireless mesh network.

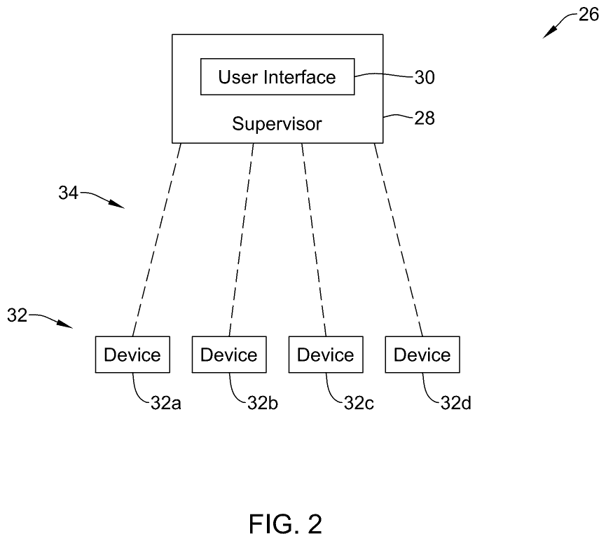

FIG. 2 is a schematic block diagram showing an illustrative system 26. The illustrative system 26 may be considered as being an example of the system 10, and vice versa. The system 26 includes a supervisor 28. The supervisor 28 may be manifested as an application executing a computer such as a computer server and/or a smartphone and/or may be manifested as an application that is operatively coupled to a memory. The supervisor 28 may include or be configured to facilitate display of a user interface 30. In some cases, the user interface 30 may be a display for displaying information or may be configured to display information via a display. In some cases, the user interface 30 may include or be operatively coupled to a data entry device such as a keyboard, mouse, trackball or electronic writing surface. In some cases, the user interface 30 may include a touch screen that functions as a display as well as providing data entry functionality.

The illustrative system 26 includes a number of devices 32 that are operatively coupled in a mesh network 34. The devices 32 are individually labeled as 32a, 32b, 32c and 32d. While a total of four devices 32 are shown, it will be appreciated that this is merely illustrative, as the system 26 may include any number of devices 32, and in some cases may include a substantially greater number of devices 32. In some cases, some of the devices 32 may represent gateway hubs. In some cases, at least some of the devices 32 may be IoT devices. These are just examples.

In some cases, the IoT devices may include one or more smart sockets, as detailed herein, and the supervisor 28 may be operatively coupled to some or all of the one or more smart sockets. In such instances, the supervisor 28 may be configured to detect a change in a plug state of the plug receptacle based on information indicative of the plug state that is received from the plug detection sensor. As used herein, a plug state refers to either a plug present state or a plug absent state in a receptacle (e.g., an individual receptacle) of a smart socket. In some instances, a plug detection sensor is configured to detect whether the receptacle is in a plug present state or a plug absent state. For example, the plug detection sensor can detect whether a plug is initially absent (e.g., at a time of installation or initialization of a smart socket) and can subsequently detect whether a plug is present in a receptacle of the smart socket. Similarly, the plug detection sensor can detect a plug absent state once the plug is removed from the receptacle and can subsequently detect another plug present state when a plug is reinserted in the receptacle, etc. That is, the plug detection sensor can be configured to detect any quantity of plug present states and/or plug absent states over an operational lifetime of a smart socket. As used herein a change in plug state refers to a change from a plug present state to a plug absent state or a change from a plug absent state to a plug present state. In some instances, a supervisor 28 is configured to detect a change in a plug state. However, in some instances, another component such as the plug detection sensor can be configured to detect the change in the plug state.

The controllers and/or supervisor 28 can include one or more processing devices (not illustrated) and one or more memories (not illustrated) for storing non-transitory machine-readable instructions and data used, generated, or collected by the processing device(s). Each processing device (e.g., a hardware processing device) can execute instructions, such as those that may be loaded into or otherwise stored on a memory. The instructions could be used for various aspects herein pertaining to reducing energy consumption of a region of a facility. For instance, the instructions can include instructions to receive, from a plug detection sensor in a respective smart socket of the plurality of smart sockets, a signal indicative of a first plug state of a respective plug receptacle in the respective smart socket, wherein the first plug state corresponds to a plug present state of the respective plug receptacle or a plug absent state of the respective plug receptacle; receive, from the plug detection sensor, a signal indicative of a second plug state of the plug receptacle in the respective smart socket, wherein the second plug state is the other of the plug present state or the plug absent state; identify a change from the first plug state to the second plug state; and/or responsive to identification of the change, send a control signal to automatically switch power off or switching power on to one or more of the plurality of electrical sockets. The processing device includes any suitable processing device, such as one or more microprocessors, microcontrollers, digital signal processors, application specific integrated circuits (ASICs), field programmable gate arrays (FPGAs), or discrete circuitry. The memory and a persistent storage are examples of storage devices, which represent any structure(s) capable of storing and facilitating retrieval of information (such as data, program code, and/or other suitable information on a temporary or permanent basis). The memory may represent a random-access memory or any other suitable volatile or non-volatile storage device(s). The persistent storage may contain one or more components or devices supporting longer-term storage of data, such as a read only memory, hard drive, flash memory, or optical disc. The controllers and/or supervisor could also include at least one network interface, such as one or more Ethernet interfaces or wireless transceivers.

The supervisor 28 can be configured to store one or more plug states associated with the one or more smart sockets. For instance, the supervisor 28 can store one or more plug states associated with each of the smart sockets. The plug states can include a plug present and/or a plug absent state. The plug present state can correspond to a plug of an electrical appliance being present in a plug receptacle of a smart socket of the one or more smart sockets. Conversely, the plug absent state can correspond to an absence of a plug in the plug receptacle of the smart socket.

The supervisor 28 can be configured to detect a change in a plug state of the plug receptacle based on information indicative of the plug state that is received from the plug detection sensor. For example, the supervisor 28 can compare a plug state (e.g., a most recent plug state) stored in a memory to a signal indicative of a plug state (e.g., a current plug state) that is received from a plug detection sensor. The supervisor 28 can detect a change in a plug state of a plug receptacle when the stored plug state (e.g., a plug absent state) is different than the plug state (e.g., a plug present state) indicated by the signal receive from plug detection sensor. Responsive to detection of the change, the supervisor 28 can store the plug state indicated by the signal received from the plug detection sensor in memory. For instance, the supervisor can update a current plug state of a plug receptacle to the plug state indicated by the signal received from the plug detection sensor. In this way, a plug state of the plug receptacle that is stored in memory can be updated based on the signal indicative of the plug state received from the plug detection sensor. Alternatively, the supervisor 28 can detect an absence of change in a plug state of the plug receptacle when the stored plug state (e.g., a plug absent state) is the same (matches) the plug state (e.g., a plug absent state) indicated by the signal receive from plug detection sensor. Responsive to detection of an absence of a change, the supervisor 28 can cease to update a plug state in the memory or can store the same plug state in the memory.

In response to identifying that the plug state changed from the plug absent state to the plug present state, the supervisor 28 can be configured to send a control signal to one or more of the smart sockets that causes the corresponding socket controller to switch on power to the corresponding plug receptacle. For instance, a control signal can be sent from the supervisor 28 to an individual smart socket to switch power on for one or more plug receptacles in the individual smart socket. In some examples, a control signal can be sent from the supervisor 28 to an individual smart socket to switch power on for an individual plug receptacle (e.g., which is associated with a plug detection sensor that initially detected the presence of a plug in or proximate to the individual plug receptacle) in the individual smart socket. However, in some instances one or more control signals can be sent from the supervisor to an individual socket to switch power on for a plurality plug receptacles (e.g., which each are associated with a plug detection sensor that initially detected the presence of a plug in or proximate to one or more of the plurality of plug receptacles) in the individual smart socket.

In response to identifying that the plug state change from the plug present state to the plug absent state, the supervisor 28 can be configured to send a control signal to the one or more of the smart sockets that causes the corresponding socket controller to switch off power to the corresponding plug receptacle in the one or more smart sockets. For instance, a control signal can be sent from the supervisor 28 to an individual smart socket to switch power off for one or more plug receptacles in the individual smart socket. In some examples, a control signal can be sent from the supervisor 28 to an individual smart socket to switch power off for an individual plug receptacle (e.g., which is associated with a plug detection sensor that initially detected the absence of a plug in or proximate to the individual plug receptacle) in the individual smart socket. However, in some instances one or more control signals can be sent from the supervisor to an individual socket to switch power off for a plurality plug receptacles (e.g., which each are associated with a plug detection sensor that initially detected the absence of a plug in or proximate to one or more of the plurality of plug receptacles) in the individual smart socket.

As detailed herein, a plug state (e.g., a current plug state) of one or more receptacles can be detected by a plug detection sensor. That is, a smart socket (e.g., an individual smart socket) can include one or more plug detection sensors (e.g., one or more push button switches and/or one or more proximity sensors), as detailed herein. In some instances, a smart socket can include an individual plug detection sensor, as detailed herein. However, in some instances a smart socket can include a plurality of plug detection sensors, as detailed herein.

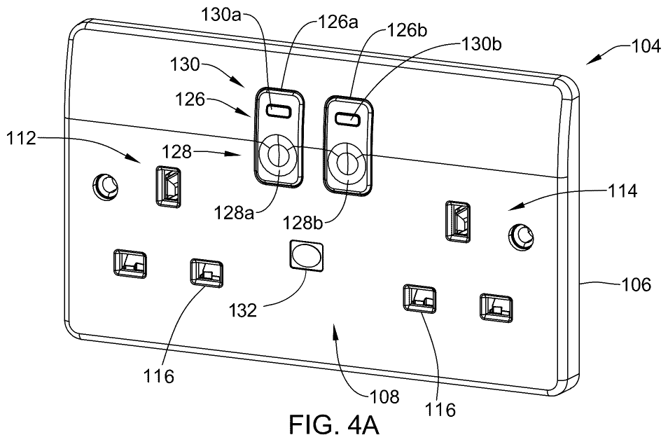

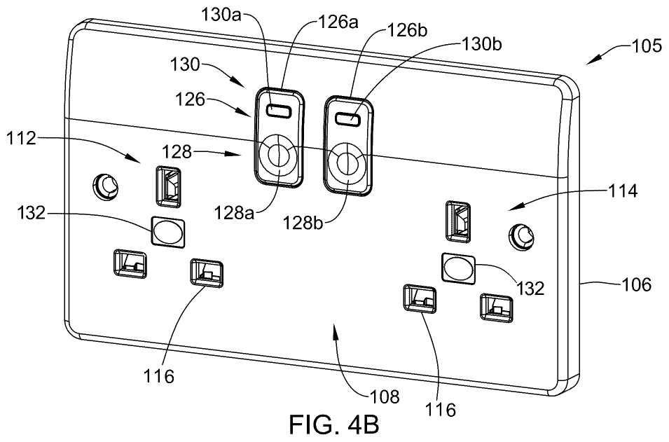

A ratio of plug detection sensors to plug receptacles in an individual smart socket can be 1:1, 1:2, 1:3, 1:4, etc. In any case, the plug detection sensor can be configured to detect whether or not a plug of an electrical appliance is physically present in one or more plug receptacles of a smart socket (e.g., an individual smart socket. In some instances, the plug detection sensor can be configured to detect whether or not a plug is present in any one of a plurality of plug receptacles in the smart socket. For instance, the plug detection sensor can be an individual plug detection sensor that is physically located between two or more plug receptacles in the smart socket and can be configured to detect whether a plug is present in any one of the two or more plug receptacles of the smart socket. Stated differently, the individual plug detection sensor can be associated with (e.g., configured to detect a plug status of one or more of) a group or set of plug receptacles in the smart socket. FIG. 4A, as detailed herein, provides an example illustration of an embodiment of a smart socket employing an individual plug detection sensor with a group or set of plug receptacles in the smart socket. Thus, a ratio of plug detection sensors to plug receptacles in the smart socket can be a 1:2 ratio or greater (e.g., 1:3, etc.). Employing an individual plug detection sensor that is configured to configured to detect whether a plug is present in any one of the two or more plug receptacles of an individual smart socket can promote aspects herein such as reducing the complexity and/or cost of the individual smart socket and/or reducing computation overhead and/or reducing network traffic (e.g., wireless network traffic) associated with signals sent from or to the individual smart socket.

However, in some instances, the plug detection sensor can be configured to detect whether or not a plug is present in an individual plug receptacle in the smart socket. For instance, the plug detection sensor can be an individual plug detection sensor that is physically located between or adjacent to one or more slots of a plug receptacle (e.g., an individual plug receptacle configured to receive an individual plug) in a smart socket and can be configured to detect whether a plug is present in the plug receptacle of the smart socket. Stated differently, the individual plug detection sensor can be associated with (e.g., configured to detect a plug status of) an individual plug receptacle in the smart socket. In such instances, each individual plug receptacle in a smart socket can have a corresponding plug detection sensor. Thus, a ratio of plug detection sensors to plug receptacles in the smart socket can be a 1:1 ratio. FIG. 4B, as detailed herein, provides an example illustration of an embodiment of an individual smart socket employing individual plug detection sensors that correspond to individual plug receptacles in the smart socket. Employing an individual plug detection sensor that is configured to detect whether a plug is present in an individual plug receptacle of an individual smart socket can promote aspects herein such as permitting greater granularity of control of the plug receptacles in one or more smart sockets and can yield a resultant further reduction in energy savings (e.g., due to being able to detect and alter the power to the smart socket on a per plug receptacle basis).

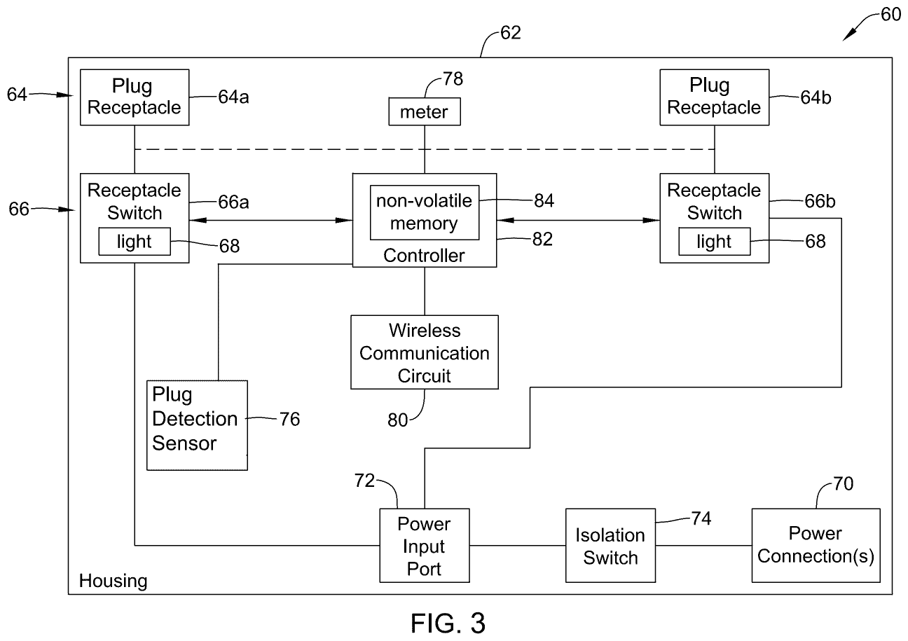

As mentioned, FIG. 3 provides an example illustration of an embodiment of a smart socket 60 employing an individual plug detection sensor that is associated with a group or set of plug receptacles in the smart socket. The illustrative smart socket 60 may be considered as being an example of an IoT device such as the IoT devices 20, 22, 24, 44 and 46, or more generically the devices 32. The illustrative smart socket 60 includes a housing 62. As shown, the housing 62 houses a number of components of the smart socket 60, although some components of the smart socket 60 may be considered as being accessible from a position exterior to the housing 62. The illustrative smart socket 60 includes plug receptacles 64, individually labeled as 64a and 64b. The plug receptacles 64 are each configured to receive an electrical plug of an electrical appliance. While a pair of plug receptacles 64 are shown, in some cases the smart socket 60 may include only one plug receptacle 64 or may include additional plug receptacles. In some cases, the smart socket 60 may include three or more plug receptacles 64.

The illustrative smart socket 60 includes a plug detection sensor 76. The plug detection sensor is visible from and/or may protrude from outside of the housing 62. The plug detection sensor 76 can be configured to automatically detect a plug present state when the plug from an electrical appliance is present in or proximate to the plug receptacle such as one or more of the plug receptacles 64. Similarly, the plug detection sensor 76 can be configured to automatically detect a plug absent state when the plug from the corresponding electrical appliance is absent in or is not proximate to one or more plug receptacles. The plug detection sensor 76 can detect a plug state (e.g., a plug present state and/or a plug absent state) continuously, periodically, and/or responsive to an input (e.g., responsive to a signal sent from the supervisor to the plug detection sensor. Examples of suitable plug detection sensors include proximity sensors and various mechanical switches that are configured to detect a plug state of one or more plug receptacles.

Examples of suitable proximity sensors include inductive proximity sensors, capacitive proximity sensors, ultrasonic proximity sensors, photoelectric proximity sensors, magnetic proximity sensors, laser proximity sensors, and hall effect proximity sensors, among others. Examples of suitable mechanical switches include a push-button switch or a snap-action switch. For instance, the plug detection sensor 76 can be manifested as a mechanical switch the protrudes a distance from the outside of the housing 62 (e.g., protrudes a distance from the front side of the housing at least when in a first position). For example, the mechanical switch can protrude a distance from the housing and can otherwise be configured to physically contacted by a surface of a plug when the plug is present in a plug receptacle. For instance, the mechanical switch can be predisposed to first position in which a portion of the mechanical sensor protrudes a first distance from the exterior surface of the housing and, responsive to a plug being present in a plug receptacle, can be configured to move to a second position where the portion of the mechanical sensor closer to the housing, is coplanar with the housing, or is located within the housing. The first position of the mechanical sensor can correspond to a plug absent state, while the second position of the mechanical sensor can correspond to or be indicative of a plug present state of a plug receptacle.

As illustrated in FIG. 4A, the plug detection sensor 76 can correspond to an individual plug detection sensor that is positioned between two or more plug receptacles (e.g., receptacles 64a/64b). For example, the plug detection sensor 76 can be space equally or located at a midpoint between two plug receptacles, as illustrated in FIG. 4A. That is, the plug detection sensor 76 can be manifested as in individual plug detection sensor located equally proximate to adjacent plug receptacles, in some instances. However, the location and/or a quantity of the plug detection sensors 76 in a smart socket can be varied.

In various instances, the plug detection sensor 76 may be manifested as a proximity sensor that is configured to detect the presences in any one of the two or more plug receptacles. For instance, the plug detection sensor 76 may be proximity sensor configured to detect a plug in any one of the plug receptacles 64a/64b or may be configured as a proximity sensor that is configured to detect the presence of a plug in a first plug receptacle independent of whether or not a plug is present in the second plug receptacle. That is, the granularity of the plug detection may be configured to globally detect a plug in any one of the two or more plug receptacles or may be configured to detect a respective plug (or absence of a plug) in each of the two or more plug receptacles. For instance, the plug detection sensor 76 may include one or more directional proximity sensors that are configured to detect the presence or absence of a plug in one or more of the plug receptacles.

The illustrative smart socket 60 includes several receptacle switches 66, individually labeled as 66a and 66b. Each of the receptacle switches 66 are operatively coupled between the power input port 72 and the corresponding plug receptacle 64. When in a closed position, the receptacle switch 66 allows power to pass from the power input port 72 to the corresponding plug receptacle 64. When in an open position, the receptacle switch 66 does not allow power to pass from the power input port 72 to the corresponding plug receptacle 64. In some cases, the corresponding light 68 may indicate that power is being allowed to flow to the corresponding plug receptacle 64. For example, the light 68 may glow green to indicate the flow of power, and may glow red (or be off) in order to indicate that no power is flowing to the plug receptacle 64. In some cases, each of the receptacle switches 66a, 66b can be manually switched by a user. In some cases, the each of the receptacle switches 66a, 66b can be switched by the controller 82 based on instructions received from a user via the wireless communication circuit 80. In some cases, each of the receptacle switches 66a, 66b may be electronically controlled by the controller 82, using input signals from manual push buttons associated with each of the receptacle switches 66a, 66b on the illustrative smart socket 60. When so provided, the controller 82 may prevent power from being delivered to a plug receptacle 64 even when the manual push button associated with the plug receptacle 64 is pushed by a user. That is, the controller 82 may lock a particular plug receptacle 64 and prevent a user from manually activating the plug receptacle 64 by pushing the push button that is associated with the plug receptacle 64. In some cases, the controller 82 may lock one or more plug receptacle 64 based on a programmed schedule. While two receptacle switches 66 are shown, in some cases, there may be only one receptacle switch 66 or three or more receptacle switches 66. In some cases, there will be one receptacle switch 66 for each plug receptacle 64. In some cases, each of the receptacle switches 66 may include a light 68 such as but not limited to an LED. The light 68 may be used to indicate whether power is turned on to a corresponding plug receptacle 64, for example. The light 68 may represent a single light or a plurality of lights, for example. The light 68 is visible from outside of the housing 62. In some cases, the controller 82 is configured to control the illumination of the light 68.

The illustrative smart socket 60 includes one or more power connection(s) 70 for connecting to a power source (not shown). In some cases, the power connection(s) 70 may include a live connection, a neutral connection and a ground connection. The power connection(s) 70 may include one or more wiring terminals for connecting to power line wires. The power connection(s) 70 may additionally or alternatively include one or more wires. A power input port 72 is configured to receive input power from the power connection(s) 70. In some cases, the power connection(s) 70 include a live connection and a neutral connection, and the isolation switch 74 is electrically coupled between the live connection and the power input port 72.

The illustrative smart socket 60 includes an isolation switch 74, for instance, that is electrically coupled between the power connection(s) 70 and the power input port 72. As an example, the isolation switch 74 may include a latching relay, and the controller 82 may be configured to switch the isolation switch 74 by controlling a latching relay of the isolation switch 74.

The isolation switch 74, when in a closed position, allows power to pass from the power connection(s) 70 to the power input port 72, and when in an open position, does not allow power to pass from the power connection(s) 70 to the power input port 72 thereby isolating the power input port 72 from the power source for at least some of the plug receptacles. For instance, power may be turned off or on via the isolation switch 74 for a given plug receptacle independent of whether power is turned off or on for another plug receptacle in the smart socket 60. In various embodiments, the isolation switch 74 can be configured to move between the closed position and the open position responsive to receipt of a signal such as a signal received from the controller 82 (e.g., which receives a signal from the supervisor). In some instances, the isolation switch 74 can automatically power on or power off the one or more plug receptacles regardless of a position of the receptacle switches 66a, 66b e.g., can be manually switched on or off.

For instance, even though a receptacle switch 66 is manually switched on (e.g., permitting the corresponding plug receptacle to be powered on) a signal can be sent from the supervisor to the controller 82 which can supersede the position of the receptacle switch and thus can cause the plug receptacle to be powered off (e.g., via the isolation switch 74), for instance, when an absence of a plug in the plug receptacle is detected by the plug detection sensor 76. As such, the approaches herein can realize reductions in energy consumption. Similarly, even though a receptacle switch 66 is switched off (e.g., permitting the corresponding plug receptacle to be powered off) a signal can be sent from the supervisor to the controller 82 which can supersede the position of the receptacle switch and thus can cause the plug receptacle to be powered on (e.g., via the isolation switch 74), for instance, when a plug in the plug receptacle is detected by the plug detection sensor 76. Thus, the approaches herein can ensure the power is provided to an electrical appliance that is plugged into the plug receptacle. For instance, the approaches herein can ensure the power is provided to an electrical appliance subsequent to the plug of the electrical appliance being plugged into and detected by the plug detection sensor, thereby mitigating any safety or fire hazard concerns that may otherwise be associated with plugging a plug of an electrical device into a smart socket that is powered on prior to the plug being disposed in a plug receptacle. Stated differently, in some instances the methods and systems herein can provide safety locks e.g., automatic identification of plug presence and powering on (providing power to) a plug receptacle when (e.g., after) plug presence is detected (e.g., on a per receptacle or per socket basis. Yet, the methods and systems herein can also provide facility or building managers with peace of mind, for instance, with regard to having smart sockets (or at least some receptacles in a smart socket) powered off e.g., when no load/plug is connected thereto.

The illustrative smart socket 60 includes a meter 78 that is configured to capture one or more electrical characteristics of power that is delivered to each plug receptacle 64. A wireless communication circuit 80 is configured for wireless communicating with a remote device such as a mesh network, a gateway hub, a mobile device or another IoT device, for example.

A controller 82 is operatively coupled with at least each of the receptacle switch 66, the meter 78, the isolation switch 74, the plug detection sensor 76, and the wireless communication circuit 80. The controller 82 is configured to receive from the meter 78 one or more of the captured electrical characteristics of the power that is delivered to the corresponding plug receptacle 64 and to transmit via the wireless communication circuit 80 one or more power parameters that are based at least in part on one or more of the received electrical characteristics of the power that is delivered to the plug receptacle 64. The controller 82 is configured to receive one or more commands via the wireless communication circuit 80, including a command that causes the controller 82 to switch the appropriate receptacle switch 66 between the closed position and the open position and/or can cause the isolation switch 74 to power on or power off one or more of the plug receptacles 64 (e.g., based on whether or not a plug is detected by the plug detection sensor 76 and/or a change in a plug status, as described herein).

The controller 82 may be configured to transmit and/or receive one or more commands (e.g., transmitting or receiving command from the supervisor 82) via the wireless communication circuit 80 including a command that causes the controller 82 to switch power on or off to one or more plug receptacles, for instance, responsive to detection of the presence or absence of a plug by the plug detection sensor 76 and responsive to identification of a change in a plug status of the one or more plug receptacles, as described herein.

FIG. 4A is a front perspective view of an illustrative smart socket 104. The smart socket 104 may be considered as being an example of the smart socket 60. The smart socket 104 includes a housing 106 having a front side 108 and an opposing back side (not illustrated). As shown, the smart socket 104 includes a first plug receptacle 112 and a second plug receptacle 114, both of which are accessible from the front side 108 of the housing 106. The smart socket 104 includes a pair of receptacle switches 126, individually labeled as 126a and 126b. Each receptacle switch 126 includes a receptacle switch button 128, individually labeled as 128a and 128b. Each receptacle switch 126 includes a light 130, individually labeled as 130a and 130b. As mentioned, the smart socket 104 includes a one or more power connections. Each of the one or more power connections can be manifested as wire terminals configured to accommodate a wire inserted therein, with a corresponding screw that can be tightened down to secure the corresponding wire in place.

As shown, the smart socket 104 includes a plug detection sensor 132 which is accessible from the front side 108 of the housing 106. Thus, the plug receptacles 112/114 and the plug detection sensor 132 are disposed in the same exterior surface (such as the front side 108) of the smart socket 104. The plug detection sensor 132 can be manifested as a mechanical switch and/or a proximity sensor, as detailed herein. In some instances, the plug detection sensor 132 (e.g., a mechanical switch) may protrude a distance from the front side 108 of the housing 106, as detailed herein. As illustrated in FIG. 4A, the smart socket 104 can include an individual plug detection sensor (e.g., the plug detection sensor 132) that is associated with (e.g., located between) two or more plug receptacles. In such instances, the plug detection sensor can be configured to detect a presence or an absence of a plug of an electrical appliance in any one of the two or more plug receptacles that are associated with the plug detection sensor 132. However, other configurations of the smart socket 60 are possible. For instance, the relative locations and/or quantities of the plug detection sensor 132 and/or the plug receptacles 112/114, may be varied.

FIG. 4B is a front perspective view of another illustrative smart socket 105. The smart socket 105 is analogous to the smart socket 104, with the difference that the smart socket 105 includes a plurality of plug detection sensors 132 rather than the individual plug detection sensor 132 in the smart socket 104. As illustrated in FIG. 4B, in some instances a quantity of the plug detection sensors 132 can be equal to a quantity of plug receptacles in the smart socket 105. Stated differently, the smart socket 105 can include a 1:1 ratio of plug detection sensors to plug receptacles. In some embodiments, each of the plug detection sensors 132 in the smart socket 105 can be the same type of plug detection sensors. For instance, each of the plug detection sensors 132 can be proximity sensors or can be mechanical switches. However, in some instances, one or more of the plug detection sensors in a smart socket can be a different type of plug detection sensor than a type of at least one other plug detection sensor in the smart socket.

As illustrated in FIG. 4B, each of the plug detection sensors 132 is an individual plug detection sensor that is physically located between respective slots of a corresponding plug receptacle (e.g., an individual plug receptacle configured to receive an individual plug) in the smart socket 105. That is, each of the plug detection sensors 132 can be configured to detect whether a plug is present in the corresponding (individual) plug receptacle of the smart socket. That is, in some embodiments a plurality of plug receptacles is included in an individual smart socket and each of the plurality of plug receptacles can have a corresponding individual plug detection sensor that is configured to detect a plug state of an individual plug receptacle (e.g., that is most proximate to the corresponding individual plug detection sensor). In such instances, the plug detection sensor may be configured to only detect a plug state of the individual plug receptacle (e.g., not detect the plug state of any of the other plug receptacles).

In some instances, the plug receptacles can be manifested as a two prong plug receptacle or a three prong plug receptacle. For instance, as illustrated in FIGS. 4A-4B, the plug receptacles 112/114 can each be manifested as three prong plug receptacles. In some examples, the plug detection sensors herein can be located proximate to or between one or more prongs of the two prong plug receptacle or the three prong plug receptacle. For instance, as illustrated in FIG. 4B, the plug detection sensors 132 can be located between two or more (e.g., three) slots of the plug receptacles 112/114. Having the plug detection sensors 132 be located between the prongs of the plug receptacles can promote aspects herein such as promoting detection on a per plug receptacle basis of the presence of a plug of an electrical appliance. A plug inserted (present) in a plug receptacle may physically contact a plug detection sensor manifested as a mechanical switch located between slots of the plug receptacle, thereby altering a state of the mechanical switch which results in the transmission of a signal to a supervisor that is indicative of the presence of the plug. While FIG. 4B illustrates the plug detection sensors 132 as being located between respective slots of the plug receptacles, other configurations are possible. For instance, the plug detection sensors 132 may be located adjacent to but not between the slots and yet permit plug state detection (e.g., responsive to physical contact of the plug detection sensors 132 but a portion of the plug when present in the plug receptacle, etc.).

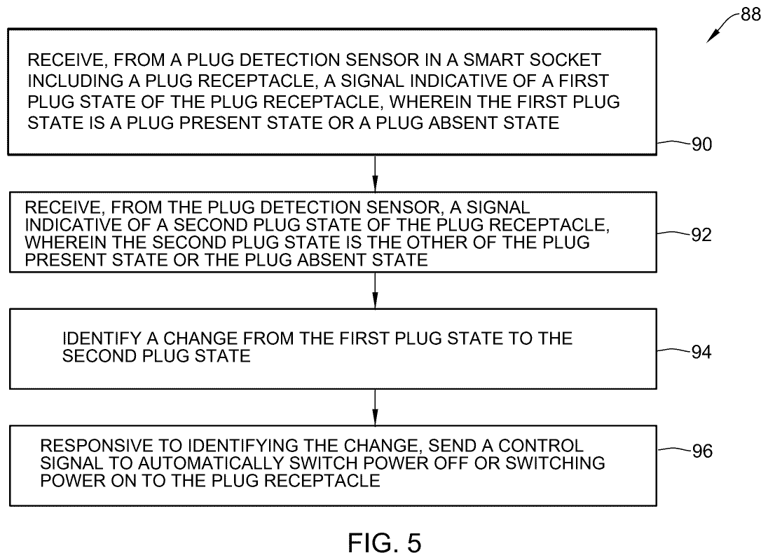

FIG. 5 is a flow diagram showing an illustrative method 88 for controlling energy consumption of a building based on a plug state detected by a plug state detector. Aspects of the illustrative method can be performed with or via one or more of the components (e.g., a supervisor, etc.) described herein. The building includes a plurality of smart sockets (such as the smart socket 60) connected to the power line network. Each smart socket is configured with one or more plug receptacles (such as the plug receptacle 112) to receive an electrical plug from a corresponding electrical appliance and each smart socket is configured to wirelessly report one or more power parameters of power delivered by the smart socket from the power line network to the corresponding electrical appliance.

Each smart socket includes at least one plug detection sensor (such as the plug detection sensor 76) configured to detect whether or not a plug is present in one or more of the plug receptacles. Each smart socket includes a receptacle switch (such as the receptacle switch 66a) and/or an isolation switch such as the isolation switch 74) electrically selective isolate one or more of the smart sockets from the power line network of the building. Stated differently, the receptacle switch and/or the isolation switch can be configured to power on or power off one or more of the plug receptacles responsive to the plug detection sensor detecting the presence or absence of a plug in the one or more plug receptacles, as detailed herein. For example, the plug detection sensor can detect a current plug state of a plug receptacle and a supervisor can compare the current plug state to a previous plug state (e.g., a most recent prior plug state stored in a memory of the supervisor) to detect a change in the plug state, as detailed herein.

For instance, the illustrative method 88 includes receiving, from a plug detection sensor in a smart socket including a plug receptacle, a (first) signal indicative of a first plug state (e.g., a plug absent state) of the plug receptacle, where the first plug state is a plug present state or a plug absent state, as indicated at block 90. Similarly, the illustrative method 88 includes receiving, from a plug detection sensor in a smart socket including a plug receptacle, a (second) signal indicative of a second plug state (e.g., a plug absent state) of the plug receptacle, as indicated at block 92. As mentioned, the first plug and the second plug state can be a plug present state or a plug absent state. In various instances, the first signal and second signal can be received wirelessly by a supervisor, as detailed herein.

The illustrative method 88 includes identifying a change from the first plug state to the second plug state, as indicated at block 94. For example, a supervisor (such as the supervisor 12) can identify the change from the first plug state to the second plug state, as detailed herein.

The illustrative method 88 includes sending a control signal to automatically switch power off or switching power on to the plug receptacle. For instance, the illustrative method 88 can include sending a control signal to automatically switch power off or switching power on to the plug receptacle responsive to identifying the change from the first plug state to the second plug state, as indicated at block 96.

In some embodiments, a supervisor is configured to send the control signal to automatically switch power off or switch power on to the plug receptacle based on a given plug state and/or a change in a plug state of one or more plug receptacles, as detailed herein. For example, in response to identifying that the plug state change from the plug present state to the plug absent state, the supervisor can be configured to send the control signal to the one or more smart sockets that causes the corresponding socket controller to switch off power to the corresponding plug receptacle automatically (e.g., in the absence of a delay or predetermined timeout period subsequent to identifying the change, in the absence of sending a notification to a user, or both). That is, the methods and systems herein can automatically detect the presence or absence of a plug in a plug receptacle and can automatically power on or power off the plug receptacle accordingly in the absence of any manual intervention but a user (e.g., pushing a physical button on or associated with the smart socket and/or plug receptacle). Thus, the approaches herein can automatically and timely (e.g., in the absence of notifying an awaiting a user response or manual intervention) reduce energy consumption of smart sockets and buildings including smart sockets. Responsive to receipt of a signal from the supervisor, a smart socket can power on or power off one or more plug receptacles, as detailed herein.

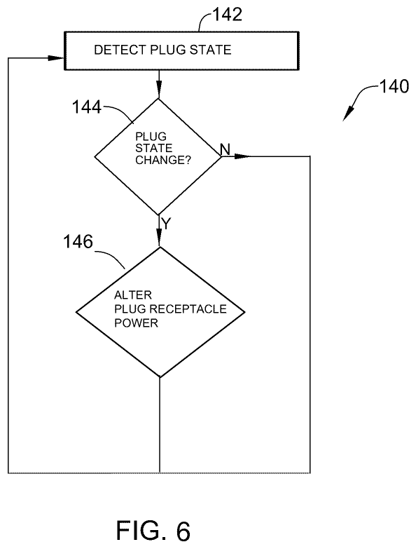

FIG. 6 is a flow diagram showing an illustrative method 140 for controlling energy consumption of a building based on a plug state detected by a plug state detector of a smart socket. A plug state of one or more plug receptacles in a smart socket is detected by a plug detector of a smart socket, as indicated at block 142. As mentioned, the plug state can be determined continuously by the plug state detector, can be determined periodically (e.g., every few seconds, etc.), or can be determined responsive to an input (e.g., responsive to receipt of a signal from a supervisor e.g., supervisory controller).

At decision block 144, a determination is made as to whether there is a change in a plug state of the plug receptacle. As mentioned, the determination can be made by a supervisor e.g., supervisory controller. If yes, control passes to block 146 and a power state of the one or more plug receptacles is altered (e.g., the one or more plug receptacles are powered on or powered off). If no, control returns to block 142 and the plug detection sensor can continue or resume detection of a plug state of the plug receptacle.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A system for controlling energy consumption of a building, the system comprising:
one or more smart sockets located in the building each having:
a plug receptacle for receiving a plug from a corresponding electrical appliance,
a plug detection sensor configured to detect a plug state of the plug receptacle,
wherein the plug state includes a plug present state and a plug absent state; and
a socket controller that is configured to switch power on or off to the plug receptacle; and
a supervisor operatively coupled to each of the one or more smart sockets, the supervisor configured to detect a change in a plug state of the plug receptacle based on information indicative of the plug state that is received from the plug detection sensor, wherein:
in response to identifying that the plug state of changed from the plug absent state to the plug present state, the supervisor is configured to send a control signal to a smart socket of the one or more of the smart sockets that causes the corresponding socket controller to switch on power to the corresponding plug receptacle of the smart socket; and
in response to identifying that the plug state change from the plug present state to the plug absent state, the supervisor is configured to send a control signal to the smart socket of the one or more of the smart sockets that causes the corresponding socket controller to switch off power to the corresponding plug receptacle of the smart socket.

2. The system of claim 1, wherein the plug receptacle and the plug detection sensor are disposed in the same exterior surface of each of the one or more smart sockets.

3. The system of claim 1, wherein the plug detection sensor is configured to automatically detect the plug present state when the plug from the corresponding electrical appliance is present in or proximate to the plug receptacle.

4. The system of claim 3, wherein the plug detection sensor is configured to automatically detect the plug absent state when the plug from the corresponding electrical appliance is absent in or not proximate to the plug receptacle.

5. The system of claim 1, wherein the plug receptacle further comprises a two-slot plug receptacle or a three-slot plug receptacle, and wherein the plug detection sensor is located proximate to one or more slots of the two-slot plug receptacle or the three-slot plug receptacle.

6. The system of claim 5, wherein the plug detection sensor is located between two or more slots of the two-slot plug receptacle or the three-slot plug receptacle.

7. The system of claim 1, wherein the plug detection sensor further comprises a proximity sensor configured to sense the plug state of the plug receptacle.

8. The system of claim 1, wherein the plug detection sensor further comprises a mechanical switch configured to sense the plug state of the plug receptacle.

9. The system of claim 8, wherein the mechanical switch further comprises a push-button switch or a snap-action switch.

10. The system of claim 1, wherein the plug receptacle is included in a plurality of plug receptacles in each of the one or more smart sockets, and wherein the plug detection sensor is an individual plug detection sensor associated with each of the plurality of plug receptacles.

11. The system of claim 1, wherein the plug receptacle is included in a plurality of plug receptacles in each of the one or more smart sockets, and wherein the plug detection sensor is included in a plurality of plug detection sensors in each of the one or more smart sockets.

12. The system of claim 11, wherein a quantity of the plurality of plug receptacles is equal to a quantity of the plurality of plug detection sensors.

13. The system of claim 11, wherein each of the plurality of plug detection sensors are the same type of plug detection sensor.

14. The system of claim 1, wherein the supervisor is operatively coupled to each of the one or more smart sockets via a wireless connection.

15. The system of claim 1, wherein the supervisor is operatively coupled to each of the one or more smart sockets via a gateway hub that is separate from the supervisor, wherein the gateway hub is in wireless communication with each of the one or more smart sockets.

16. A method for reducing energy consumption of a region of a facility, comprising:
receiving, from a plug detection sensor in a smart socket including a plug receptacle, a signal indicative of a first plug state of the plug receptacle, wherein the first plug state is a plug present state or a plug absent state;
receiving, from the plug detection sensor, a signal indicative of a second plug state of the plug receptacle, wherein the second plug state is the other of the plug present state or the plug absent state;
identifying a change from the first plug state to the second plug state; and
responsive to identifying the change, sending a control signal to automatically switch power off or switch power on to the plug receptacle.

17. The method of claim 16, further comprising automatically sending the control signal, from a supervisor, to switch power off or switch power on to the plug receptacle.

18. A supervisor operatively coupled to a plurality of smart sockets in a building, each of the plurality of smart sockets having a housing including one or more plug receptacles and one or more plug detection sensors, the supervisor comprising:
a memory storing non-transitory machine readable instructions; and
a processing device operatively coupled to the memory and configured to execute the non-transitory machine readable instructions to:
receive, from a plug detection sensor in a respective smart socket of the plurality of smart sockets, a signal indicative of a first plug state of a respective plug receptacle in the respective smart socket, wherein the first plug state corresponds to a plug present state of the respective plug receptacle or a plug absent state of the respective plug receptacle;
receive, from the plug detection sensor, a signal indicative of a second plug state of the plug receptacle in the respective smart socket, wherein the second plug state is the other of the plug present state or the plug absent state;
identify a change from the first plug state to the second plug state; and
responsive to identification of the change, send a control signal to automatically switch power off or switching power on to the plug receptacle.

19. The supervisor of claim 18, wherein the non-transitory machine readable instructions further comprise instructions executable by the processing device to store, in a memory, a plug state of each of the plug receptacles.

20. The supervisor of claim 19, wherein the first plug state corresponds to a most recent prior plug state of the plug receptacle stored in the memory, and wherein the second plug state corresponds a current plug state of the plug receptacle as indicated by the signal received from the plug detection sensor.
